(19) United States
(12) Patent Application Publication
(10) Pub. No.: US 2021/0239939 A1
(43) Pub. Date: Aug. 5, 2021

(54) CONTROL DEVICE, IMAGING DEVICE, SYSTEM, CONTROL METHOD, AND PROGRAM

(71) Applicant: SZ DJI TECHNOLOGY CO., LTD., Shenzhen (CN)

(72) Inventor: Linglong ZHU, Shenzhen (CN)

(21) Appl. No.: 17/235,883

(22) Filed: Apr. 20, 2021

Related U.S. Application Data
(63) Continuation of application No. PCT/CN2019/113941, filed on Oct. 29, 2019.

(30) Foreign Application Priority Data
Oct. 31, 2018 (JP) 2018-206150

(51) Int. Cl. G02B 7/28; G03B 13/36; G02B 27/64; H04N 5/232

(52) U.S. Cl. CPC G02B 7/28; H04N 5/23248; G02B 27/64; G03B 13/36

(57) ABSTRACT

A control device includes a processor and a memory storing instructions that, when executed by the processor, cause the processor to obtain temperature information measured by a temperature sensor of an imaging device and perform adjustment on a focus position of a lens of the imaging device in response to a temperature change amount being greater than or equal to a predetermined value during the imaging device capturing a plurality of images at a predetermined time interval.

### CROSS-REFERENCE TO RELATED APPLICATIONS

This application is a continuation of International Application No. PCT/CN2019/113941, filed Oct. 29, 2019, which claims priority to Japanese Patent Application No. 2018-206150, filed Oct. 31, 2018, the entire contents of both of which are incorporated herein by reference.

### TECHNICAL FIELD

The present disclosure relates to a control device, an imaging device, a system, a control method, and a program.

### BACKGROUND

Patent document 1 discloses a method for correcting the focus shift caused by lens expansion or contraction caused by a temperature change. Patent document 1: Japanese Patent Application Publication No. 2013-242353.

### SUMMARY

In accordance with the disclosure, there is provided a control device including a processor and a memory storing instructions that, when executed by the processor, cause the processor to obtain temperature information measured by a temperature sensor of an imaging device and perform adjustment on a focus position of a lens of the imaging device in response to a temperature change amount being greater than or equal to a predetermined value during the imaging device capturing a plurality of images at a predetermined time interval.

Also in accordance with the disclosure, there is provided an imaging device including a lens, an image sensor used to receive light through the lens, a temperature sensor, a processor, and a memory storing instructions that, when executed by the processor, cause the processor to obtain temperature information measured by the temperature sensor and perform adjustment on a focus position of the lens in response to a temperature change amount being greater than or equal to a predetermined value during the imaging device capturing a plurality of images at a predetermined time interval.

Also in accordance with the disclosure, there is provided a control method including obtaining temperature information measured by a temperature sensor of an imaging device and performing adjustment on a focus position of a lens of the imaging device in response to a temperature change amount being greater than or equal to a predetermined value during the imaging device capturing a plurality of images at a predetermined time interval.

### BRIEF DESCRIPTION OF THE DRAWINGS

FIG. 1 is a perspective view of a system 5 consistent with embodiments of the disclosure.

FIG. 2 is a schematic functional block diagram of an example imaging device 100.

FIG. 3 is a schematic diagram showing changes in temperature with time since start of time-lapse photography.

FIG. 4 is a schematic flow chart of processing by an imaging controller 110 during time-lapse photography.

FIG. 5 is a schematic diagram showing a modified example of control of the imaging device 100.

FIG. 6 is a schematic diagram of an example unmanned aerial vehicle (UAV) carrying the imaging device 100.

FIG. 7 is a schematic diagram showing an example computer 1200.

Reference numerals: System 5; UAV 10; UAV main body 20; Gimbal 50; Imaging device 60; Imaging device 100; Imaging member 102; Temperature sensor 104; Imaging controller 110; Obtaining circuit 112; Focus controller 114; Image sensor 120; Memory 130; Imaging unit 140; Gimbal 150; Main body 160; Display 162; Operation button 164; Grip 166; Base 168; Lens unit 200; Lens 210; Lens driver 212; Lens controller 220; Memory 222; Remote control 300; Solid line 201; Dashed line 302; Computer 1200; Host controller 1210; CPU 1212; RAM 1214; Input/Output controller 1220; Communication interface 1222; ROM 1230.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The embodiments of the present disclosure will be described with reference to the flow charts and block diagrams. As used herein, the blocks may represent operation processes or components of the device that perform operations. The specific processes and components may be implemented by programmable circuits and/or processors. The circuits may include digital and/or analog hardware circuits, may include integrated circuits (ICs) and/or discrete circuits. The programmable circuits may include reconfigurable hardware circuits. The reconfigurable hardware circuits may include logical operations, such as the logical operation AND, the logical operation OR, the logical operation XOR, the logical operation NAND, and the logical operation NOR, etc. The reconfigurable hardware circuits may also include storage elements, such as flip-flops, registers, field programmable gate arrays (FPGAs), and programmable logic arrays (PLAs), etc.

The operations specified in the flow chart or block diagram may be implemented in the form of program instructions stored on a computer-readable storage medium, which may be sold or used as a standalone product. The computer-readable storage medium may be any suitable device that may store program instructions, which may include an electronic storage medium, a magnetic storage medium, an optic storage medium, an electromagnetic storage medium, and a semiconductor storage medium, etc. The computer-readable storage medium may be, for example, a Floppy® disk, a soft disk, a hard disk, a random-access memory (RAM), a read-only memory (ROM), an erasable programmable read-only memory (EPROM or flash memory), an electrically erasable programmable read-only memory (EEPROM), a static random-access memory (SRAM), a compact disc read-only memory (CD-ROM), a digital versatile disc (DVD), a Blu-ray disc, a memory stick, or an integrated circuit chip, etc.

The computer-readable instructions may include any one of source code or object code described in any combination of one or more programming languages. The source code or the object code includes traditional procedural programming languages. The traditional programming language may be assembly instructions, instruction set architecture (ISA) instructions, machine instructions, machine-related instructions, microcode, firmware instructions, status setting data, an object programming language, e.g., Smalltalk, JAVA®, or C++, etc., or “C” programming language. The computer-readable instructions may be provided locally or provided to a processor or a programmable circuit of a general-purpose computer, a special-purpose computer, or another programmable data processing device via a wide area network (WAN), e.g., a local area network (LAN), or the Internet. The processor or the programmable circuit may execute computer-readable instructions to perform the operations specified in the flow chart or block diagram. The processor may be a computer processor, a processing unit, a microprocessor, a digital signal processor, a controller, or a microcontroller, etc.

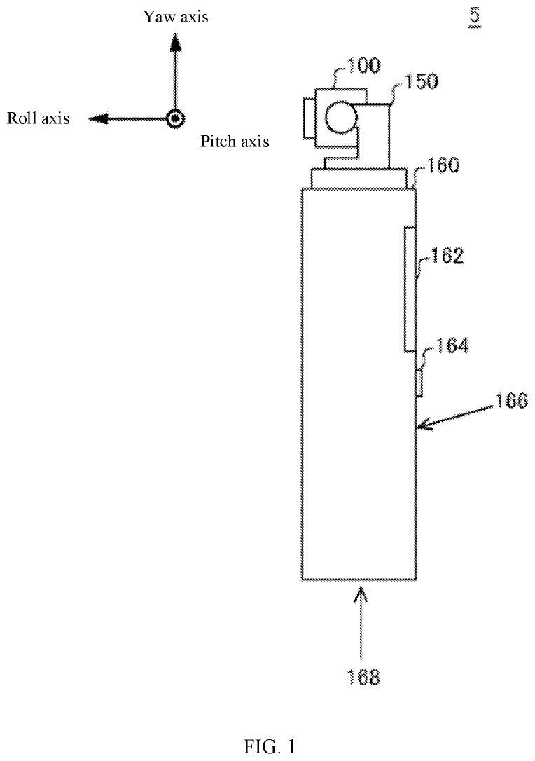

FIG. 1 is a perspective view of a system 5 consistent with embodiments of the disclosure. The system 5 includes an imaging device 100, a gimbal 150, and a main body 160. The system 5 is, for example, a stabilization device.

The gimbal 150 is arranged at the main body 160. The gimbal 150 can rotatably support the imaging device 100. The gimbal 150 includes a yaw axis, a roll axis, and a pitch axis. The gimbal 150 rotatably supports the imaging device 100 with the yaw axis, the roll axis, or the pitch axis as a center. The gimbal 150 is included in an example supporting mechanism that supports the imaging device 100 in a manner that can adjust the attitude thereof.

The main body 160 includes a display 162 and an operation button 164. The operation button 164 is provided at a position where a user can perform an operation when the user holds the grip 166 by hand. The operation button 164 is an operation member that receives instructions for operating the gimbal 150 and the imaging device 100 from the user. The operation button 164 includes, for example, a shutter button and a video recording button. When the shutter button is pressed, the imaging device 100 captures a still image. When the video recording button is pressed, the imaging device 100 captures a dynamic image.

The display 162 displays a dynamic image or a still image captured by the imaging device 100. The display 162 displays images captured by the image sensor 120 and various setting information of the imaging device 100, etc. The display 162 may include a touch panel.

The system 5 can be placed on a flat surface, such as a table, and can be used in a state where the system 5 is approximately stationary. For example, when the system 5 is in a stationary state by placing a base 168 of the main body 160 on a table, the imaging device 100 performs time-lapse photography. Time-lapse photography is also called low-speed photography, or interval photography, etc. In a time-lapse photography process, a plurality of images are captured at a specified predetermined time interval. The imaging device 100 records the plurality of images captured by time-lapse photography as a dynamic image to generate a time-lapse dynamic image. A time-lapse dynamic image is a dynamic image in which a plurality of images captured by the imaging device 100 are reproduced at a time interval shorter than the time interval for capturing the plurality of images.

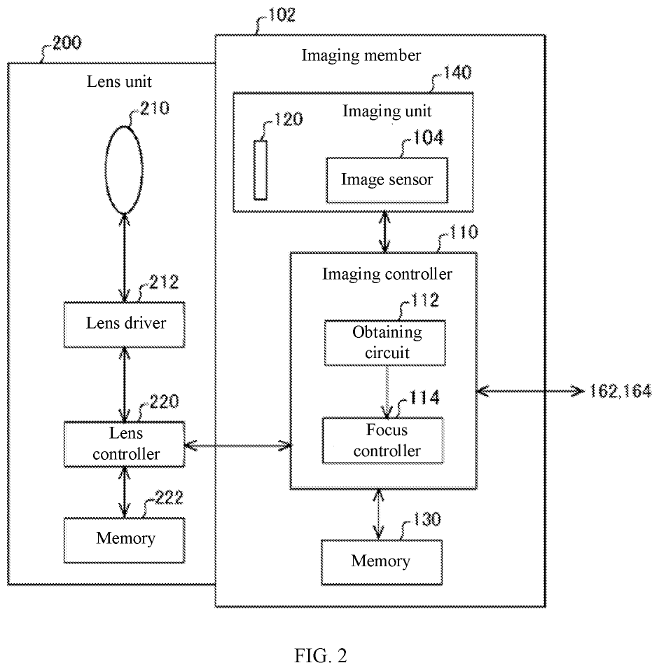

FIG. 2 is a schematic functional block diagram of an example imaging device 100. The imaging device 100 includes an imaging member 102 and a lens unit 200. The imaging member 102 includes an imaging unit 140, an imaging controller 110, and a memory 130.

The imaging unit 140 includes an image sensor 120 and a temperature sensor 104. The image sensor 120 may include a charge coupled device (CCD) or a complementary metal oxide semiconductor (CMOS). The image sensor 120 receives light through a lens 210 included in the lens unit 200. The image sensor 120 outputs image data of an optical image formed by the lens 210 to the imaging controller 110. The temperature sensor 104 measures a temperature of the image sensor 120. The temperature sensor 104, for example, is mounted at a substrate of the image sensor 120. Information indicating a temperature measured by the temperature sensor 104 is output to the imaging controller 110. In addition, in the description of the embodiments, the temperature measured by the temperature sensor 104 is sometimes referred as “temperature.”

The imaging controller 110 may include the microprocessor, e.g., a central processing unit (CPU) or a microprocessor unit (MPU), or a microcontroller, e.g., a microprogrammed controller (MCU), etc. The memory 130 may be the computer-readable storage medium and may include at least one of an SRAM, a dynamic random-access memory (DRAM), an EPROM, an EEPROM, or a flash memory such as a USB memory. The memory 130 stores a program for the imaging controller 110 to control the image sensor 120, etc. The memory 130 may be provided inside a casing of the imaging device 100. The memory 130 may be detachably mounted at the casing of the imaging device 100. The imaging controller 110 obtains the information indicating an instruction from the user received by the operation button 164 and outputs control instructions to the imaging unit 140 and the lens unit 200.

The imaging controller 110 includes an obtaining circuit 112 and a focus controller 114. The obtaining circuit 112 obtains the information indicating a temperature measured by the temperature sensor 104. The focus controller 114 controls an adjustment of a focus position of the lens 210. The focus controller 114 outputs a control instruction to the lens controller 220 included in the lens unit 200 according to the information indicating the temperature obtained by the obtaining circuit 112 and the information indicating the instruction from the user received by the operation button 164.

The lens unit 200 includes the lens 210, a lens driver 212, a lens controller 220, and a memory 222. The lens 210 may include at least one lens. For example, the lens 210 may include a focus lens and a zoom lens. At least some or all of the lens included in the lens 210 are arranged to be movable along an optical axis of the lens 210. The lens unit 200 may be an interchangeable lens detachably provided on the imaging member 102.

The lens driver 212 enables at least some or all of the lens included in the lens 210 to move along the optical axis of the lens 210. The lens driver 212 includes a motor that enables at least some or all of the lens included in the lens 210 to move along the optical axis of the lens 210. The lens controller 220 drives the lens driver 212 according to a lens control instruction from the imaging member 102 to move the zoom lens or the focus lens included in the lens 210 along the optical axis direction, thereby performing at least one of zooming or focusing. The lens control instruction is, for example, a zoom control instruction or a focus control instruction.

The memory 222 stores control values for the focus lens and zoom lens that are moved by the lens driver 212. The memory 222 may include at least one of an SRAM, a DRAM, an EPROM, an EEPROM, or a flash memory such as a USB memory.

When a power of the imaging device 100 is turned on and an instruction indicating to perform time-lapse photography is obtained from the user through the operation button 164, the imaging controller 110 outputs an imaging control instruction to the imaging unit 140 to cause the image sensor 120 to perform an imaging operation at a specified predetermined time interval to capture a plurality of images.

When the imaging device 100 captures a plurality of images at the specified predetermined time interval, the focus controller 114 adjusts the focus position of the lens 210 every time when a temperature change amount measured by the temperature sensor 104 is greater than or equal to a predetermined value. The focus controller 114 can adjust the focus position of the lens 210 through autofocus (AF). Specifically, during the time-lapse photography of the image sensor 120, every time when a temperature increase indicated by the information obtained by the obtaining circuit 112 is greater than or equal to the predetermined value, the focus controller 114 adjusts the focus position of the lens 210 through AF. The focus controller 114 adjusts the focus position of the lens 210 through, for example, contrast AF.

When the power of the imaging device 100 is turned on and the imaging device 100 starts to operate, a heat generated by a power circuit and a heat generated by the operation of the imaging unit 140, the imaging controller 110, the lens controller 220, and the lens driver 212 cause the temperature of the lens unit 200 to rise. A lens included in the lens 210 and a holding member that holds the lens included in the lens 210 may expand or contract due to a change in temperature. Therefore, due to the temperature change of the lens unit 200, a lens interval of the lens 210 changes, and the focus position of the lens 210 changes. As described above, the focus position of the lens 210 is adjusted every time when the temperature change amount is greater than or equal to the predetermined value, to enable the focus controller 114 to suppress a large change in the focus position during the time-lapse photography.

In addition, when an amount of adjustment (“adjustment amount”) of the focus position exceeds a predetermined adjustment value, the focus controller 114 may cancel the adjustment of the focus position. The predetermined adjustment value may be calculated based on at least an F number of the lens, i.e., a ratio of a focal length of the lens to a diameter of an entrance pupil of the lens. For example, a diameter of a permissible circle of confusion can be δ, and the predetermined adjustment value can be calculated via F. When an adjustment amount of the focus position exceeds the value calculated based on a current F number, the focus controller 114 may cancel the adjustment of the focus position.

The focus controller 114 may determine the focus position after an adjustment using a position obtained by weighting the focus position before the adjustment and the focus position adjusted to focus on a shooting object with a predetermined weighting coefficient greater than 0. For example, 0.5 can be used as the weighting coefficient. Even if the temperature change amount after a last adjustment of the focus position is less than the predetermined value, the focus controller 114 may adjust the focus position when an elapsed time since a last adjustment of the focus position is greater than or equal to a predetermined time value.

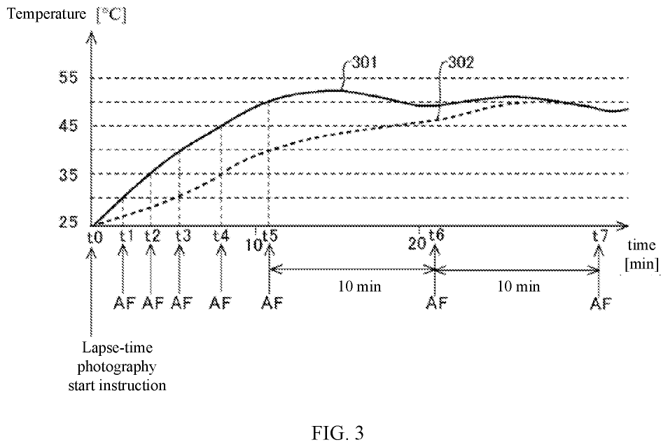

FIG. 3 is a schematic diagram showing changes in temperature with time since start of time-lapse photography. As shown in FIG. 3, the horizontal axis represents the time since the power of the imaging device 100 is turned on, and the vertical axis represents temperature. The solid line 301 represents the change of the temperature measured by the temperature sensor 104 over time. FIG. 3 shows a case where the time-lapse photography is started immediately after the power of the imaging device 100 is turned on.

When it is instructed to start the time-lapse photography at time t0, the focus controller 114 adjusts the focus position of the lens 210 through AF for a shooting object at a position specified by the user. Subsequently, the imaging controller 110 causes the image sensor 120 to repeatedly perform the imaging operation at a time interval specified by the user. The temperature at time t0 is 25° C. The focus controller 114 stores the temperature at time t0.

When the imaging controller 110 attempts to cause the image sensor 120 to perform the imaging operation at time t1, the focus controller 114 compares the temperature at time t0 with a current temperature. As shown in FIG. 3, the temperature at time t1 rises to 30° C. The focus controller 114 compares the temperature at time t0, which is the time when the focus position of the lens 210 is last adjusted through AF, with the current temperature. When the difference between the temperature at time t0 and the current temperature is greater than or equal to 5° C., the focus controller 114 performs an adjustment to adjust the focus position of the lens 210 through AF. Thus, when the imaging controller 110 causes the image sensor 120 to perform an imaging operation at time t1, a significant change in the focus position due to the change in temperature may be suppressed.

Similarly, at time t2 after time t1, the focus controller 114 compares the temperature at time t1 when a last autofocus is performed with the current temperature. Because the difference between the temperature at time t1 and the current temperature is greater than or equal to 5° C., Therefore, the focus controller 114 performs a focus adjustment of the lens 210 through AF. Similarly, at times t3, t4, and t5, the temperature rises by 5° C. since times t2, t3, and t4, when a last autofocus is performed. Therefore, the focus controller 114 adjusts the focus position of the lens 210 through AF. Thus, when the imaging controller 110 causes the image sensor 120 to perform an imaging operation at each time, a significant change in the focus position of the lens 210 due to the change in temperature may be suppressed, thereby preventing the focus position from significantly changing during time-lapse photography.

As shown in FIG. 3, a dashed line 302 represents the temperature of the lens 210. Because the image sensor 120 is one of heat sources, the temperature of the image sensor 120 rises more rapidly compared with the temperature of the lens 210. Especially at the beginning of the time-lapse photography, the difference between the temperature of the image sensor 120 and the temperature of the lens 210 is relatively large, and the difference of temperature decreases with time. In addition, the temperature of the lens 210 is information for explaining the operation of the focus controller 114 consistent with the embodiments of the disclosure. A manufactured imaging device 100 may not have a function of measuring the temperature of the lens 210.

As shown in FIG. 3, in an example embodiment, the difference between the temperature in a period after time t5 and the temperature at time t5 is within 5° C. As shown by the dashed line 302, the temperature of the lens 210 continues to rise after time t5. Therefore, the focus controller 114 adjusts the focus position of the lens 210 by AF at time t6 after 10 minutes elapse since time t5 when the focus position of the lens 210 is last adjusted by AF. In addition, at time t7 after 10 minutes elapse since time t6, the focus position of the lens 210 is adjusted by AF. Thus, a possible change in temperature of the lens 210 is considered even when the imaging device 100 starts to operate and the temperature rise of the image sensor 120 becomes smaller, and the focus position is adjusted through AF, thereby preventing the focus position from significantly changing during time-lapse photography.

As shown in FIG. 3, in an example embodiment, when a temperature difference of 5° C. occurs since a last adjustment of the focus position through AF, or when 10 minutes elapse since the last adjustment of the focus position through AF, AF is performed again to adjust the focus position. A reference value of the temperature difference (also referred to as a “temperature reference”) and a reference value of the elapsed time (also referred to as a “time reference”) to determine whether to perform AF again can be set according to a model of the imaging device. Generally, if the diameter of the permissible circle of confusion is δ, the focal depth is expressed as Fδ. Therefore, a temperature difference that can cause a focus position change of Fδ may be set as the reference value of the temperature difference to determine whether to perform AF again. Similarly, a time delay of the temperature change of the lens 210 caused by the temperature change of a temperature measurement object measured by the temperature sensor 104 may vary depending on the model of the imaging device. Therefore, the reference value of the elapsed time to determine whether to perform AF again may be set through performing a test in advance.

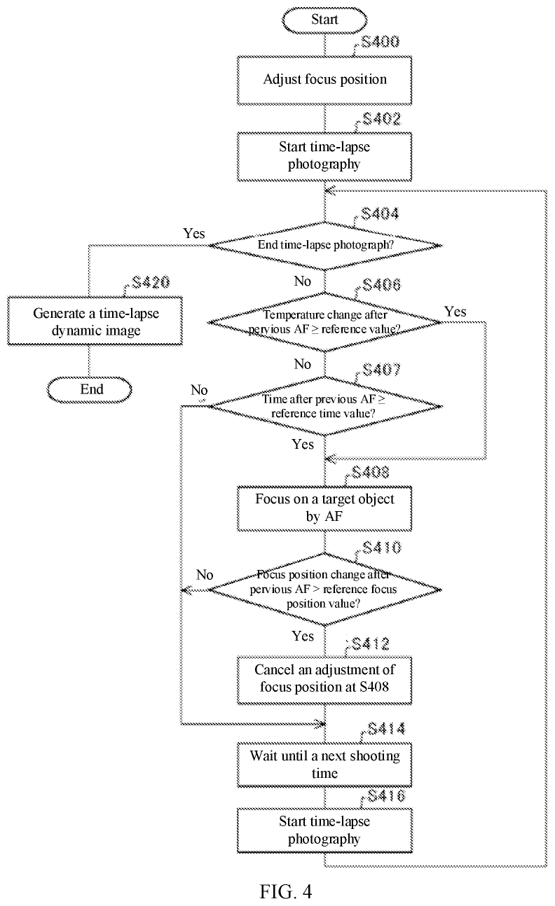

FIG. 4 is a schematic flow chart of processing by an imaging controller 110 during time-lapse photography. When the power of the imaging device 100 is turned on and an instruction to start time-lapse photography is received, the processing of the flow chart shown in FIG. 4 is started.

At S400, the focus controller 114 adjusts the focus position through AF. At S400, the position of a shooting object, which is used as a focus target, can be specified by the user. Then, when AF is performed during time-lapse photography, the focus controller 114 performs focus control at a same position as the focus target position at S400.

At S402, the imaging controller 110 starts time-lapse photography. At S404, the imaging controller 110 determines whether to end time-lapse photography. For example, when the elapsed time since the time-lapse photography is started at S402 is equal to the time for time-lapse photography specified by the user, the imaging controller 110 determines to end the time-lapse photography.

When it is determined not to end the time-lapse photography at S404, at S406, the focus controller 114 determines whether the temperature difference between the temperature when the focus position is adjusted in the previous AF and the current temperature is greater than or equal to the reference value of the temperature difference. For example, the focus controller 114 determines whether the temperature difference is greater than or equal to 5° C. When the temperature difference is less than the reference value of the temperature difference, at S407, the focus controller 114 determines whether the elapsed time since the focus position is adjusted in the last AF is greater than or equal to the reference value of the elapsed time. For example, the focus controller 114 determines whether the elapsed time is greater than or equal to 10 minutes. When the elapsed time is less than the reference value of the elapsed time, at S414, the imaging device 100 waits until a next shooting time of the time-lapse photography. At S416, shooting is performed once, and process S404 is performed. When the elapsed time is greater than or equal to the reference value of the elapsed time, process S408 is performed. In addition, when it is determined that the temperature difference between the temperature when the focus position is adjusted through a last AF and the current temperature is greater than or equal to the reference value of the temperature difference at S406, process S408 is performed.

At S408, the focus controller 114 controls the lens 210 to focus on the shooting object through AF. The focus controller 114 controls the lens 210 to focus on the shooting object through, for example, contrast AF. At S410, the focus controller 114 determines whether the difference between the focus position determined through a last AF and the focus position determined by AF at S408 exceeds a threshold value. When the difference between the focus position determined in the last AF and the focus position determined in the AF in process S408 does not exceed the threshold value, S414 is performed. Thus, shooting is performed while maintaining the focus position determined through AF at S408.

If, at S410, it is determined that the difference between the focus position determined in the last AF and the focus position determined in the AF at S408 exceeds the threshold value, then at S412, the focus controller 114 cancels the adjustment of the focus position performed at S408 and S414 is performed. Specifically, the focus controller 114 causes a focus lens of the lens 210 to return to the position of the focus lens determined through a last AF and S414 is performed. Therefore, a possibility of performing focus control on an object other than a desired shooting object may be reduced when, for example, an object passes in front of the imaging device 100.

In addition, if, at S404, it is determined to end the time-lapse photography, then at S420, the imaging controller 110 combines a plurality of images captured at S416 to generate a time-lapse dynamic image and stores the time-lapse dynamic image in the memory 130, and the processing of this flow chart is ended.

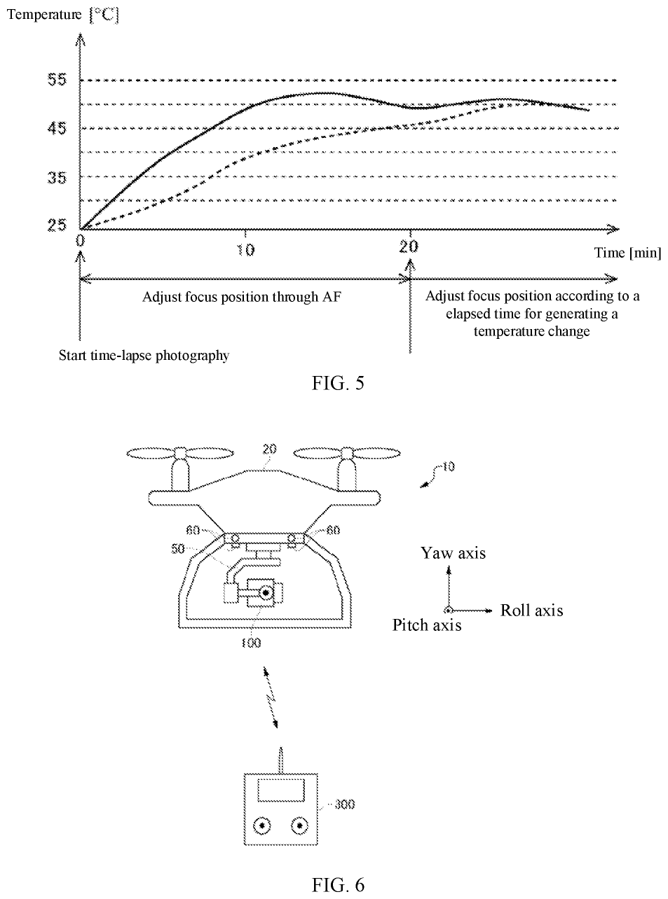

FIG. 5 is a schematic diagram showing a modified example of control of the imaging device 100. As shown in FIG. 5, after 20 minutes since the power of the imaging device 100 is turned on, as described with reference to FIGS. 1 to 4, every time a temperature difference of 5° C. occurs with respect to a temperature of a previous AF, or every time after 10 minutes elapse since a previous AF, the focus controller 114 adjusts the focus position through AF. During a time of 20 minutes since when the power of the imaging device 100 is turned on, the focus controller 114 adjusts the focus position through AF. Therefore, the focus controller 114 can adjust the focus position during a predetermined time since when the power of the imaging device 100 is turned on. After the predetermined time elapses since when the power of the imaging device 100 is turned on, every time when the temperature change amount is greater than or equal to the predetermined value, the focus controller 114 can also adjust the focus position. For example, the focus controller 114 may obtain each of a plurality of images captured at the predetermined time interval after adjusting the focus position through AF during the predetermined time since when the power of the imaging device 100 is turned on. Therefore, a desired shooting object may be continued to be focused on during a period to predict that the temperature rises significantly immediately after the power supply of the imaging device 100 is turned on and a period when a large focus change occurs due to the temperature rise.

The imaging device 100 described above can be mounted at a mobile object. The imaging device 100 may also be mounted at an unmanned aerial vehicle (UAV) as shown in FIG. 6. The UAV 10 includes a UAV main body 20, a gimbal 50, a plurality of imaging devices 60, and an imaging device 100. The gimbal 50 and the imaging device 100 are included in an example of an imaging system. The UAV 10 is included as an example mobile object propelled by a propulsion system. In addition to the UAV, the mobile object may also include another flight object movable in the air, such as an airplane, a vehicle movable on the ground, or a ship movable on the water, etc.

The UAV main body 20 includes a plurality of rotors. The plurality of rotors are included as an example propulsion system. The UAV main body 20 enables the UAV 10 to fly by controlling the rotation of the plurality of rotors. The UAV main body 20 uses, for example, four rotors to enable the UAV 10 to fly. The number of rotors is not limited to four. In addition, the UAV 10 may also be a fixed-wing aircraft without rotors.

The imaging device 100 includes an imaging camera used to shoot an object included in a desired shooting range. The gimbal 50 may rotatably support the imaging device 100. The gimbal 50 is included as an example supporting mechanism. For example, the gimbal 50 supports the imaging device 100 to enable the imaging device 100 to be rotated around a pitch axis using an actuator. The gimbal 50 supports the imaging device 100 to enable the imaging device 100 to be rotated around a roll axis or a yaw axis using an actuator. The gimbal 50 may change the attitude of the imaging device 100 by rotating the imaging device 100 around at least one of the yaw axis, the pitch axis, or the roll axis.

The plurality of imaging devices 60 include sensing cameras used to shoot surroundings of the UAV 10 to control the flight of the UAV 10. Two of the imaging devices 60 may be mounted at the nose, i.e., at a front, of the UAV 10. In addition, another two of the imaging devices 60 may be mounted at a bottom of the UAV 10. The two imaging devices 60 at the front of the UAV 10 may be paired to function as a stereo camera. The two imaging devices 60 at the bottom of the UAV 10 may also be paired to function as a stereo camera. The imaging device 60 may measure the existence of the object included in a shooting range of the imaging device 60 and a distance to the object. The imaging device 60 is included as an example measurement device for measuring the object existing in a shooting direction of the imaging apparatus 100. The measurement device may include a sensor, for example, an infrared sensor or an ultrasonic sensor, used to measure the object existing in the shooting direction of the imaging apparatus 100. Three-dimensional spatial data around the UAV 10 may be generated according to images taken by the plurality of imaging devices 60. The number of the imaging devices 60 included in the UAV 10 is not limited to four. The UAV 10 includes at least one imaging device 60. The UAV 10 may include at least one imaging device 60 at each of the nose, tail, side, bottom, and top of the UAV 10. A settable viewing angle of the imaging device 60 may be larger than the settable viewing angle of the imaging apparatus 100. The imaging device 60 may have a single focus lens or a fisheye lens.

The remote control 300 communicates with the UAV 10 to operate the UAV 10 remotely. The remote control 300 may communicate with the UAV 10 wirelessly. The remote control 300 sends the UAV 10 instruction information indicating various instructions related to the movement of the UAV 10 such as ascending, descending, accelerating, decelerating, forwarding, retreating, and/or rotating. The instruction information includes, for example, the instruction information for raising a flight altitude of the UAV 10. The instruction information may indicate a desired flight altitude of the UAV 10. The UAV 10 may move to the desired flight altitude indicated by the instruction information received from the remote control 300. The instruction information may include an ascending instruction to instruct the UAV 10 to ascend. The UAV 10 may ascend after receiving the ascending instruction. When the flight altitude of the UAV 10 has reached a maximum flight altitude, even if the ascending instruction is received, the UAV 10 may be restricted from ascending.

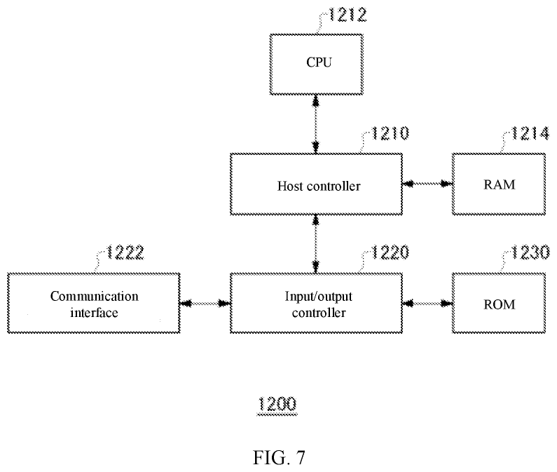

FIG. 7 is a schematic diagram of an example computer 1200 which may perform part or all of technical solutions consistent with the present disclosure. The program installed on the computer 1200 can enable the computer 1200 to function as operations associated with the device consistent with the embodiments of the present disclosure or one or more “components” of the device. Alternatively, the program may enable the computer 1200 to perform the operation or the one or more “components.” The program enables the computer 1200 to execute the process or stages of the process consistent with the embodiments of the present disclosure. The program may be executed by a CPU 1212 to make the computer 1200 execute specified operations associated with some or all blocks in the flow chart and block diagram described in this specification.

In an example embodiment, the computer 1200 includes the CPU 1212 and a RAM 1214, which are connected to each other through a host controller 1210. The computer 1200 also includes a communication interface 1222 and an input/output unit, which are connected to the host controller 1210 through an input/output controller 1220. The computer 1200 also includes a ROM 1230. The CPU 1212 operates according to the programs stored in the ROM 1230 and the RAM 1214 to control each unit.

The communication interface 1222 communicates with another electronic device via a network. A hard disk drive may store programs and data used by the CPU 1212 of the computer 1200. The ROM 1230 therein stores a boot program executed by the computer 1200 during operation, and/or the program for hardware of the computer 1200. The program is provided via the network or the computer-readable storage medium, such as a CD-ROM, a USB memory, or an IC chip. The program is stored in the RAM 1214 or the ROM 1230, which are also examples of the computer-readable storage medium, and is executed by the CPU 1212. The information processing recorded in the programs is read by the computer 1200 to cause cooperation between the programs and various types of hardware resources described above. The apparatus or method may include operations or processing to implement information according to using of the computer 1200.

For example, when communication is performed between the computer 1200 and an external device, the CPU 1212 may execute a communication program loaded in the RAM 1214 and instruct the communication interface 1222 to perform communication processing according to the processing described in the communication program. The communication interface 1222 reads the transmission data stored in a transmission buffer provided in the storage medium such as the RAM 1214 or the USB memory under the control of the CPU 1212, and transmits read transmission data to the network or writes received data from the network into a reception buffer provided in the storage medium.

In addition, the CPU 1212 may enable the RAM 1214 to read files or all or required part of database stored in an external storage medium such as the USB memory, and perform various types of processing on data in the RAM 1214. Then, the CPU 1212 may write processed data back to the external storage medium.

Various types of information such as various types of programs, data, tables, and databases may be stored in the storage medium and be performed information processing on. For the data read from the RAM 1214, the CPU 1212 may perform various types of operations, information processing, conditional judgment, conditional transfer, unconditional transfer, and information retrieval/replacement specified by the instruction sequence of the program as described in various places in the disclosure, and write the result back to the RAM 1214. In addition, the CPU 1212 may retrieve information from files, databases, etc., in the storage medium. For example, when a plurality of entries of a first attribute that are associated with attribute values of a second attribute are stored in the recording medium, the CPU 1212 may retrieve the attribute value of a specified first attribute from the plurality of entries and read the attribute value of the second attribute stored in the entry to obtain the attribute value of the second attribute associated with the first attribute satisfying a predetermined condition.

The above-described programs or software modules may be stored in the computer 1200 or in the computer-readable storage medium near the computer 1200. In addition, the storage medium such as the hard disk or the RAM provided in a server system connected to a dedicated communication network or the Internet may be used as a computer-readable storage medium to cause the program to be provided to the computer 1200 via the network.

An execution order of the actions, sequences, processes, and stages in the devices, systems, programs, and methods consistent with claims, specification, and drawings, as long as there is no special indication “in front of,” “before,” etc., and as long as an output of previous processing is not used in the subsequent processing, may be implemented in any order. Regarding the operating procedures in the claims, the specification, and the drawings, terms “first,” “next,” etc. used in the descriptions for convenience, but do not limit an implementation order.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A control device comprising:
a processor; and
a memory storing instructions that, when executed by the processor, cause the processor to:
obtain temperature information measured by a temperature sensor of an imaging device; and
perform adjustment on a focus position of a lens of the imaging device in response to a temperature change amount being greater than or equal to a predetermined value during the imaging device capturing a plurality of images at a predetermined time interval.

2. The control device of claim 1, wherein the instructions further cause the processor to cancel the adjustment of the focus position in response to an adjustment amount of the focus position exceeding a predetermined adjustment value.

3. The control device of claim 2, wherein the predetermined adjustment value is calculated based on at least an F number of the lens.

4. The control device of claim 1, wherein the instructions further cause the processor to determine the focus position after the adjustment using a position obtained by weighting the focus position before the adjustment and the focus position adjusted to focus on an object with predetermined weighting coefficients greater than 0.

5. The control device of claim 1, wherein the instructions further cause the processor to perform the adjustment in response to an elapsed time since a last adjustment of the focus position being greater than or equal to a predetermined time value.

6. The control device of claim 1, wherein the instructions further cause the processor to:
perform the adjustment during a predetermined time since a power of the imaging device is turned on; and
after the predetermined time elapses since the power of the imaging device is turned on, perform the adjustment every time in response to the temperature change amount being greater than or equal to the predetermined value.

7. The control device of claim 1, wherein the instructions further cause the processor to perform the adjustment through autofocus.

8. An imaging device comprising:
a lens;
an image sensor configured to receive light through the lens;
a temperature sensor;
a processor; and
a memory storing instructions that, when executed by the processor, cause the processor to:
obtain temperature information measured by the temperature sensor; and
perform adjustment on a focus position of the lens in response to a temperature change amount being greater than or equal to a predetermined value during the imaging device capturing a plurality of images at a predetermined time interval.

9. The imaging device of claim 8, wherein the instructions further cause the processor to cancel the adjustment of the focus position in response to an adjustment amount of the focus position exceeding a predetermined adjustment value.

10. The imaging device of claim 9, wherein the adjustment predetermined value is calculated based on at least an F number of the lens.

11. The imaging device of claim 8, wherein the instructions further cause the processor to determine the focus position after the adjustment using a position obtained by weighting the focus position before the adjustment and the focus position during the adjustment with predetermined weighting coefficients greater than 0.

12. The imaging device of claim 8, wherein the instructions further cause the processor to perform the adjustment in response to an elapse time since a last adjustment of the focus position being greater than or equal to a predetermined time value.

13. The imaging device of claim 8, wherein the instructions further cause the processor to:
perform the adjustment during a predetermined time since a power of the imaging device is turned on; and
after the predetermined time elapses since the power of the imaging device is turned on, perform the adjustment every time in response to the temperature change amount being greater than or equal to the predetermined value.

14. The imaging device of claim 8, wherein the instructions further cause the processor to perform the adjustment through autofocus.

15. A system comprising:
the imaging device of claim 8; and
a supporting mechanism configured to support and adjust an attitude of the imaging device.

16. A control method comprising:
obtaining temperature information measured by a temperature sensor of an imaging device; and
performing adjustment on a focus position of a lens of the imaging device in response to a temperature change amount being greater than or equal to a predetermined value during the imaging device capturing a plurality of images at a predetermined time interval.

17. The method of claim 16, further comprising:
canceling the adjustment of the focus position in response to an adjustment amount of the focus position exceeding a predetermined adjustment value;
determining the focus position after the adjustment using a position obtained by weighting the focus position before the adjustment and the focus position adjusted to focus on an object with predetermined weighting coefficients greater than 0; and
performing the adjustment in response to an elapsed time since a last adjustment of the focus position being greater than or equal to a predetermined time value.

18. The control device of claim 17, wherein the predetermined adjustment value is calculated based on at least an F number of the lens.

19. The method of claim 16, further comprising:
performing the adjustment during a predetermined time since a power of the imaging device is turned on;
after the predetermined time elapses since the power of the imaging device is turned on, performing the adjustment every time in response to the temperature change amount being greater than or equal to the predetermined value; and
performing the adjustment through autofocus.

20. A non-transitory computer-readable storage medium storing a program that, when executed by a computer, causes the computer to perform the method of claim 16.
